(19) United States
(12) Patent Application Publication
(10) Pub. No.: US 2009/0173247 A1
(43) Pub. Date: Jul. 9, 2009

(54) PRINTING PRESS CYLINDER

(75) Inventors: Xaver BACHMEIR, Haunswies (DE); Eduard Hoffmann, Bobingen (DE); Thomas Kandlbinder, Augsburg (DE); Norbert Dylla, Stadtbergen (DE)

Correspondence Address: CROWELL & MORING LLP;INTELLECTUAL PROPERTY GROUP, P.O. BOX 14300, WASHINGTON, DC, 20044-4300, US

(73) Assignee: Manroland AG, Offenbach/Main (DE)

(21) Appl. No.: 12/271,445

(22) Filed: Nov. 14, 2008

(30) Foreign Application Priority Data
Nov. 17, 2007 (DE) 10 2007 054 935.2

(51) Int. Cl. B41F 1/28

(52) U.S. Cl. 101/415.1

(57) ABSTRACT

A printing press cylinder is disclosed. The cylinder includes a lock-up channel extending in an axial direction of the cylinder, where a clamping piece is accommodated in the lock-up channel to clamp a plate on a surface area of the printing press cylinder. The clamping piece includes first feed slants and second feed slants. Projections of the leading edge of a to-be-clamped plate are co-operable with the first feed slants and projections of the trailing edge of a to-be-clamped plate are co-operable with the second feed slants such that the leading edge of the to-be-clamped plate is clampable in a self-centering manner between the clamping piece and a leading channel wall of the lock-up channel and the trailing edge of the to-be-clamped plate is clampable in a self-centering manner between the clamping piece and a trailing channel wall of the lock-up channel.

This application claims the priority of German Patent Document No. 10 2007 054 935.2, filed Nov. 17, 2007, the disclosure of which is expressly incorporated by reference herein.

### BACKGROUND AND SUMMARY OF THE INVENTION

The invention relates to a printing press cylinder.

Clamping plates carrying printing ink embodied as printing plates on a printing press cylinder embodied, for example, as form cylinders, is already known from practice, wherein, to do so, a printing press cylinder comprises at least one lock-up channel extending in the axial direction of the printing press cylinder, and wherein at least one clamping mechanism is respectively accommodated in the or each lock-up channel, in order to clamp at least one plate on a surface area of the printing press cylinder. The or each plate to be clamped on the printing press cylinder has a leading edge and a trailing edge, wherein the leading edge and the trailing edge can be clamped respectively with the aid of a clamping piece of a clamping mechanism in the respective lock-up channel between the respective clamping piece and a channel wall of the respective lock-up channel. In the process, the leading edge is meant to be clamped between the clamping piece and a leading channel wall of the respective lock-up channel and the trailing edge between the clamping piece and a trailing channel wall of the respective lock-up channel, wherein, in the case of printing press cylinders known from practice, it causes difficulties to always clamp the leading edge between the clamping piece and the leading channel wall of the respective lock-up channel as well as the trailing edge between the clamping piece and the trailing channel wall of the respective lock-up channel. In fact, in the case of printing presses known from practice, when clamping a plate, the leading edge can end up between the clamping piece and a trailing channel wall and the trailing edge between the clamping piece and a leading channel wall, wherein it is then not possible to properly clamp the to-be-clamped plate.

In order to make allowances for this problem, insertion aids are used in the case of printing press cylinders known from practice, which insertion aids ensure that the leading edge of a to-be-clamped printing plate is clamped between the clamping piece and the leading channel wall of the respective lock-up channel and the trailing edge is clamped between the clamping piece and the trailing channel wall of the respective lock-up channel. There is a need for a printing press cylinder, in which this can be guaranteed without utilizing special insertion aids.

Starting herefrom, the present invention is based on the objective of creating a novel printing press cylinder.

According to the invention, the clamping piece of each clamping mechanism, as viewed in the axial direction, has several feed slants, namely first feed slants for the leading edge of a to-be-clamped plate and second feed slants for the trailing edge of a to-be-clamped plate, which are positioned alternately one after another and side by side as viewed in the axial direction, wherein the leading edge of a to-be-clamped plate and the trailing edge of a to-be-clamped plate, while forming projections and recesses, are contoured in such a way that the projections of the leading edge of a to-be-clamped plate cooperate with the first feed slants of a clamping piece and the projections of the trailing edge of a to-be-clamped plate cooperate with the second feed slants of a clamping piece in such a way that the leading edge of a to-be-clamped plate can be clamped in a self-centering manner between the clamping piece and a leading channel wall of the lock-up channel, and the trailing edge of a to-be-clamped plate can be clamped in a self-centering manner between the clamping piece and a trailing channel wall of the lock-up channel.

Due to the special embodiment of the clamping piece of a clamping mechanism, which as viewed in the axial direction, has first feed slants for the leading edge of a to-be-clamped printing plate and second feed slants for the trailing edge of a to-be-clamped printing plate positioned alternately one after another and side by side, and due to the corresponding contouring of the leading edge and trailing edge with projections, which cooperate with the first and second feed slants, it is possible, without utilizing insertion aids, to clamp the leading edge of a to-be-clamped printing plate between the clamping piece and a leading channel wall of a lock-up channel in a self-centering manner, and to clamp the trailing edge of a to-be-clamped plate between the clamping piece and a trailing channel wall of a lock-up channel in a self-centering manner. In addition, it is possible to realize very small widths of a lock-up channel.

Preferred further developments of the invention are disclosed in the following description. Without being limited hereto, one exemplary embodiment of the invention is explained in greater detail in the following.

### BRIEF DESCRIPTION OF THE DRAWINGS

FIG. 1 is a schematic section of an inventive printing press cylinder embodied as a plate cylinder in the region of a lock-up channel and two printing plates to be clamped one after the other on the plate cylinder, as viewed in the circumferential direction, wherein a leading edge from one printing plate is shown and a trailing edge from a second printing plate is shown; and

FIG. 2 illustrates the leading edge and the trailing edge of the first printing plate together with clamping pieces of clamping mechanisms offset by 180° on the circumference of the plate cylinder.

### DETAILED DESCRIPTION OF THE DRAWINGS

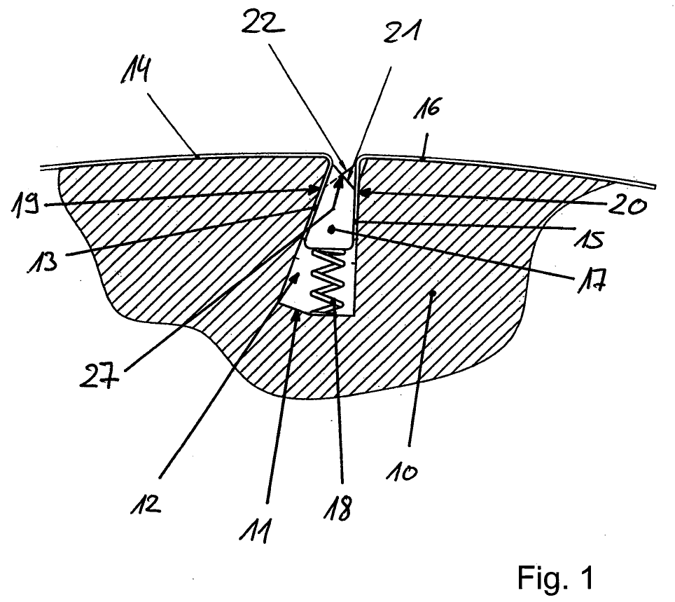

FIG. 1 shows a schematic section of an inventive printing press cylinder embodied as a plate cylinder 10 in the region of a lock-up channel 11, which extends in the axial direction of the printing press cylinder 10.

Accommodated in the lock-up channel 11 is a clamping mechanism 12, with whose help a leading edge as well as a trailing edge of at least one printing plate can be clamped in the lock-up channel 11. In the following it is assumed that the plate cylinder 10 depicted in FIG. 1 is comprised of two lock-up channels 11 that are offset from one another by 180° and that have corresponding clamping mechanisms 12 so that, as viewed in the circumferential direction, two printing plates may be clamped one after another on the plate cylinder 10. Accordingly, in FIG. 1 the clamping mechanism 12 of the lock-up channel 11 is used to clamp adjacent ends of two different printing plates, namely to clamp a leading edge 13 of a first printing plate 14 and to clamp the trailing edge 15 of a second printing plate 16. The respective other ends of these two printing plates 14, 16 can be clamped on the clamping mechanism that is positioned in the lock-up channel opposite from the lock-up channel 11 and that is not shown in FIG. 1.

The clamping mechanism 12 accommodated in the lock-up channel 11 has a clamping piece 17, which is pressed outward via a spring element 18 in the radial direction of the plate cylinder 10, in order to ultimately clamp the leading edge 13 of the printing plate 14 as well as the trailing edge 15 of the printing plate 16 in the lock-up channel 11. In the process, as FIG. 1 shows, the leading edge 13 of the printing plate 14 is clamped between the clamping piece 17 and a leading channel wall 19 of the lock-up channel 11, whereas the trailing edge 15 of the printing plate 16 is clamped between the clamping piece 17 and a trailing channel wall 20 of the lock-up channel 11.

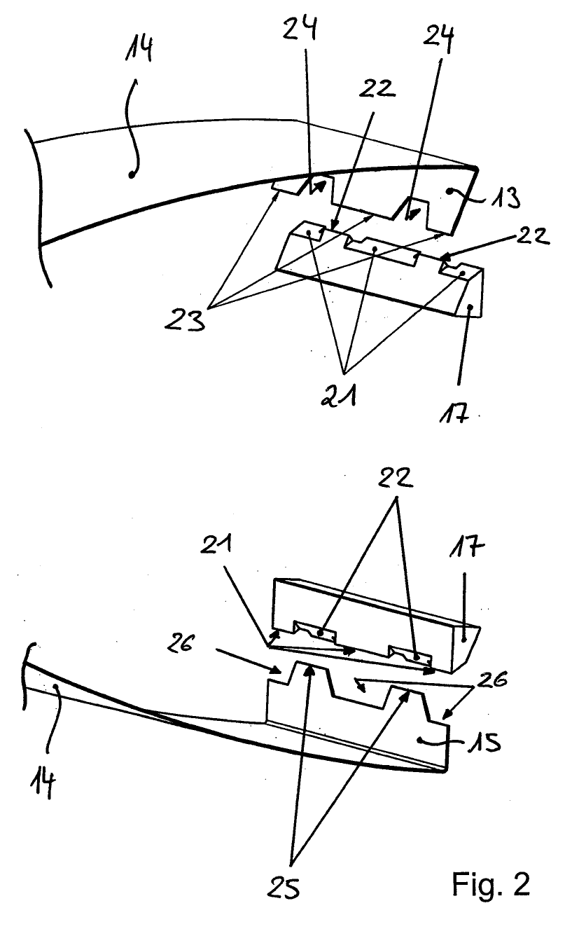

FIG. 2 schematically shows a perspective view of the printing plate 14 in the region of the leading edge 13 as well as the trailing edge 15 of the printing plate, wherein, as FIG. 2 shows, the leading edge 13 and the trailing edge 15 of the printing plate 14 are clamped on two diametrically opposed clamping pieces 17, which are positioned in diametrically opposed lock-up channels.

According to FIG. 2, each clamping piece 17 has, as viewed in the axial direction, several feed slants, namely first feed slants 21 for the leading edge 13 of a printing plate 14 and second feed slants 22 for the trailing edge 15 of a printing plate 14. The different feed slants 21, 22 are positioned, as viewed in the axial direction, alternately one after another or side by side, wherein a second feed slant 22 is respectively positioned between two respective first feed slants 21. The leading edge 13 of a to-be-clamped printing plate 14, while forming projections 23 as well as recesses 24, is contoured in such a way that the projections 23 of the leading edge 13 of a to-be-clamped printing plate 14 cooperate with the first feed slants 21 of the clamping piece 17. Likewise, the trailing edge 15 of a to-be-clamped printing plate 14, while forming projections 25 as well as recesses 26, are contoured in such a way that the projections 25 of the trailing edge 15 cooperate with the second feed slants 22 of the respective clamping piece 17.

The first feed slants 21 of the clamping pieces 17 cooperating with the projections 23 of the leading edge 13 as well as the second feed slants 22 of the clamping pieces 17 cooperating with the projections 25 of the trailing edge 15 respectively form catch zones for the leading edge 13 or the trailing edge 15 of a to-be-clamped printing plate 14, so that the leading edge 13 of the to-be-clamped printing plate 14 can be clamped in a self-centering manner between the clamping piece 17 and a leading channel wall of the respective lock-up channel and the trailing edge 15 of a to-be-clamped printing plate 14 can be clamped in a self-centering manner between the clamping piece 17 and a trailing channel wall of the respective lock-up channel, without insertion aids having to be used. The contouring of the clamping pieces 17 as well as the leading edges 13 and trailing edges 15 of to-be-clamped printing plates automatically bring about the centering of the clamping plate in the lock-up channel, so that, therefore, a leading edge 13 of a to-be-clamped printing plate is respectively clamped between the clamping piece and the corresponding leading channel wall and the trailing edge of the printing plate is clamped between the clamping piece and the corresponding trailing channel wall.

As can be seen in FIG. 2, the axial width of the first feed slants 21 of the clamping pieces 17 is adapted to the axial width of the projections 23 of the leading edge 13 of the printing plate to be clamped on the respective clamping piece. Similarly, the axial width of the second feed slants 22 of the clamping pieces 17 is adapted to the axial width of the projections 25 of the trailing edge 15 of the printing plate to be clamped to the respective clamping piece.

From FIG. 1 it is evident that, as viewed in the axial projection, the first feed slants 21 and second feed slants 22 of a clamping piece 17 positioned alternately one after another or side by side form a centering aid 27, on which a tool can be applied in order to press the clamping piece 17 down against the spring force being provided by the spring element 18 in order to detach a printing plate clamping on the plate cylinder 10.

Although the present invention was described here making reference to FIGS. 1 and 2 and using the example of a plate cylinder 10, on which printing plates are to be clamped, the invention may of course also be used in the case of a transfer cylinder in order to clamp, for example, so-called metal back blankets to the transfer cylinder.

### LIST OF REFERENCE NUMBERS

10 Plate cylinder

11 Lock-up channel

12 Clamping mechanism

13 Leading edge

14 Printing plate

15 Trailing edge

16 Printing plate

17 Clamping piece

18 Spring element

19 Leading channel wall

20 Trailing channel wall

21 First feed slants

22 Second feed slants

23 Projection

24 Recess

25 Projection

26 Recess

27 Centering aid

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing press cylinder, comprising a lock-up channel extending in an axial direction of the printing press cylinder, wherein a clamping piece is accommodated in the lock-up channel to clamp a plate on a surface area of the printing press cylinder, wherein the clamping piece, as viewed in the axial direction, includes first feed slants for a leading edge of a to-be-clamped plate and second feed slants for a trailing edge of a to-be-clamped plate, which are positioned alternately one after another and side by side as viewed in the axial direction, and wherein projections of the leading edge of a to-be-clamped plate are co-operable with the first feed slants of the clamping piece and projections of the trailing edge of a to-be-clamped plate are co-operable with the second feed slants of the clamping piece such that the leading edge of the to-be-clamped plate is clampable in a self-centering manner between the clamping piece and a leading channel wall of the lock-up channel and the trailing edge of the to-be-clamped plate is clampable in a self-centering manner between the clamping piece and a trailing channel wall of the lock-up channel.

2. The printing press cylinder according to claim 1, wherein an axial width of the first feed slants is adapted to an axial width of the projections of the leading edge of the to-be-clamped plate.

3. The printing press cylinder according to claim 1, wherein an axial width of the second feed slants is adapted to an axial width of the projections of the trailing edge of the to-be-clamped plate.

4. The printing press cylinder according to claim 1, wherein the first feed slants and the second feed slants of the clamping piece form a centering aid for a tool to be applied to the clamping piece.

5. A printing press cylinder, comprising:
a lock-up channel extending in an axial direction of the printing press cylinder; and
a clamping piece disposed in the lock-up channel;
wherein the clamping piece, as viewed in the axial direction, includes first feed slants and second feed slants positioned alternately one after another and side by side as viewed in the axial direction.

6. The printing press cylinder according to claim 5 in combination with a first printing plate and a second printing plate, wherein projections of a leading edge of the first printing plate engage with the first feed slants of the clamping piece and wherein projections of a trailing edge of the second printing plate engage with the second feed slants of the clamping piece.

7. The printing press cylinder in combination with a first printing plate and a second printing plate according to claim 6, wherein the leading edge of the first printing plate is clamped between the clamping piece and a leading channel wall of the lock-up channel and wherein the trailing edge of the second printing plate is clamped between the clamping piece and a trailing channel wall of the lock-up channel.

8. The printing press cylinder in combination with a first printing plate and a second printing plate according to claim 7, further comprising a spring disposed within the lock-up channel, wherein the spring presses the clamping piece in an outward radial direction of the printing press cylinder.
